(19) United States
(12) Patent Application Publication
(10) Pub. No.: US 2010/0235453 A1
(43) Pub. Date: Sep. 16, 2010

(54) Monitoring of instant messaging and presence services

(76) Inventors: Francesco Attanasio, Nocera Superiore (SA) (IT); Amedeo Imbimbo, Caivano (NA) (IT)

Correspondence Address: ERICSSON INC., 6300 LEGACY DRIVE, M/S EVR 1-C-11, PLANO, TX, 75024, US

(21) Appl. No.: 12/676,758

(22) PCT Filed: Sep. 21, 2007
(86) PCT No.: PCT/SE2007/050671

§ 371 Date: Mar. 5, 2010

(51) Int. Cl. G06F 15/173; G06F 15/16

(52) U.S. Cl. 709/206; 709/224

(57) ABSTRACT

The present invention relates to a methods and arrangements for monitoring instant messaging and/or presence activity at application level in a telecommunication system, which method comprises the following steps:—A request to monitor instant messaging and/or presence activity information related to a target subscriber, which information is obtainable from any type of access and not limited to SIP clients connected to a public IMS core system is sent from an agency to a receiving entity.—A requested activity involving the target subscriber is received from an Instant Messaging and Presence Services (IMPS) system to the receiving entity.—Information related to the requested activity is delivered from the receiving entity to the agency.

### TECHNICAL FIELD

The present invention relates to arrangements and methods for providing Data Retention and Lawful Interception of instant messaging and/or presence activity users.

### BACKGROUND

Instant Messaging and Presence Service IMPS (Standard term specified and used by Wireless Village), is a product that gives the end-user the possibility to see the presence, online status, of other IMPS users and communicate with them in the most efficient way, either by IM, SMS, MMS or Voice. The Ericsson IMPS solution includes functionality based on the OMA IMPS standard “OMA Instant Messaging and Presence Service V1.3 Approved Enabler”. The main features of IMPS are contact Presence, Instant Messaging and Group (chat). Presence is the key enabling technology for IMPS. It includes client device availability (my phone is on/off, in a call), user status (available, unavailable, in a meeting), location, client device capabilities (voice, text, GPRS, multimedia) and searchable personal statuses such as mood (happy, angry) and hobbies (football, fishing, computing, dancing). Since presence information is personal, it is only made available according to the user's wishes.

The user is able to see the Presence of other IMPS users and to initiate communication with these users through click actions. Presence changes from one client are instantly available to clients subscribing to presence information.

The Instant Messaging feature provides a common message routing function for Wireless Village enabled clients. By selecting “send message” for a contact an Instant Messaging session is started in which the user communicates with other users through the inter-change of Instant Messages.

The Group (chat) feature provides enabled clients with functions for establishing and maintaining chat sessions with two or more users. A client will use this feature to create a group, to establish group membership, and to assign properties such as access rights to both the group and its members. The Group feature also provides the distribution function for Instant Messages to be sent between group members.

The Group Service Feature handles the following:
Group creation
Inviting of users to groups
Reject users out of groups
Joining and leaving of groups
Searching for groups

The Group Service Feature also keeps track of the invitations that have been sent.

The OMA IMPS enables clients to connect to IMPS via Internet, 2G, 2.5G and 3G mobile networks. IMPS interfaces the mobile network via WAP GWs, SMS-Cs or GGSN to the clients. IMPS and 3GPP IP Multimedia Subsystem IMS address Presence and Messaging but the latter is targeting an IMS enabled UMTS network. The IMPS architecture can be found in OMA-AD-IMPS-V1 3-20070123-A. The Ericsson IMPS is an application that is designed to work across all networks; wireless, wireline and Internet. IMPS users can communicate over Internet, GSM and GPRS. To be noted is that the invention described in this patent application is not limited to the Ericsson IMPS solution. The Ericsson IMPS solution is just to be seen as an example.

An SSP interface is used for the connection between different IMPS domains. The SSP interface provides a single access point of the domain. A domain is where the client subscribes to, is authenticated and authorized to use the IMPS services. The SSP protocol stack consists of SSP semantics layer, syntax layer and SSP transport layer. SSP Semantics Layer defines the complete set of features and functions for interoperability among the OMA/IMPS domains. SSP Syntax Layer defines the “communication language” for the OMA/IMPS SAP's to understand the information between each other and accomplish the interoperability of the features and functions defined in SSP Semantics Layer. SSP Syntax Layer is the set of XML DTD specification. SSP Transport Layer defines the communication method that conveys the “communication language” between the WV SAP's to achieve the interoperability. While IMPS is Ericsson's solution to provide presence enhanced services for non Session Initiation Protocol SIP terminals in 2, 2.5 and 3G networks, PGM is Ericsson's solution to provide presence and group management services for SIP enabled terminals in IMS networks. Interworking between IMPS 3.0 and PGM is supported using the OMA-IMPS SSP protocol.

In many countries the operators and Internet service providers are today obliged by legal requirements to provide stored traffic data generated from public telecommunication and Internet services for the purpose of detection, investigation and prosecution of crime and criminal offences including terrorism. There are also a number of initiatives within the European Union (EU) to regulate the legal basis for data retention. The EU Parliament has recently adopted a set of amendments and by that approved the Council's proposed directive on data retention (See Directive 2006/24/EC of the European Parliament and of the Council of 15 Mar. 2006 on the retention of data generated or processed in connection with the provision of publicly available electronic communications services or of public communications networks and amending Directive 2002/58/EC). This proposal describes not only initial requirements, but also how an extension of the directive will be handled. Consequently, an essential part of operator's effort to comply with current legislation will be to secure that processes and tools are adaptable to handle an expansion of the scope for data retention. This clause presents the user requirements related to the retained data of telecommunications with the Lawful Enforcement Agency LEA being the user. The relevant terms are defined in clause 3.1. These user requirements are subject to national law and international treaties and should be interpreted in accordance with applicable national policies. ETSI DTS/LI-00039 gives guidance for the delivery and associated issues of retained data of telecommunications and subscribers. It provides a set of requirements relating to handover interfaces for the retained traffic data and subscriber data by law enforcement and other authorized requesting authorities. The requirements are to support the implementation of Directive 2006/24/EC of the European Parliament and of the Council of 15 Mar. 2006 on the retention of data. ETSI DTS/LI-00033 contains handover requirements and a handover specification for the data that is identified in EU Directive 2006/24/EC on retained data. The interfaces through which a Communication Service Provider CSP receives requests from the Requesting Authority, and transmits responses and information are denoted as Handover Interfaces.

FIG. 1A belongs to the prior art and displays the Handover Interfaces between the Data Retention System DRS at the Communication Service Provider CSP, and the Requesting Authority RA. The figure shows an Administration Function AdmF used to handle and forward requests from/to the RA. A Mediation and Delivery function MF/DF is used to mediate and deliver requested information. The Storage is used to collect and retain all possible data from external the data bases. The generic Handover Interface adopts a two port structure such that administrative request/response information and Retained Data Information are logically separated. The Handover Interface port 1 HIA transports various kinds of administrative, request and response information from/to the Requesting Authority and the organization at the CSP, which is responsible for Retained Data matters. The HIA interface may be crossing borders between countries. This possibility is subject to corresponding national law and/or international agreements. The Handover Interface port 2 HIB transports the retained data information from the CSP to the Requesting Authority. The individual retained data parameters have to be sent to the Requesting Authority at least once (if available). The HIB interface may be crossing borders between countries. This possibility is subject to corresponding national law and/or international agreements.

FIG. 1B is part of the prior art and discloses an Intercept Mediation and Delivery Unit IMDU, also called Intercept Unit, that is a solution for monitoring of Interception Related Information IRI and Content of Communication CC for the same target. The different parts used for interception are disclosed in current Lawful Interception standards (see 3GPP TS 33.108 and 3GPP TS 33.107—Release 7). A Law Enforcement Monitoring Facility LEMF is connected to three Mediation Functions MF, MF2 and MF3 respectively for ADMF, DF2, DF3 i.e. an Administration Function ADMF and two Delivery Functions DF2 and DF3. The Administration Function and the Delivery Functions are each one connected to the LEMF via standardized handover interfaces HI1-HI3, and connected via interfaces X1-X3 to an Intercepting Control Element ICE in a telecommunication system. Together with the delivery functions, the ADMF is used to hide from ICEs that there might be multiple activations by different Law Enforcement Agencies. Messages REQ sent from LEMF to ADMF via HI' and from the ADMF to the network via the X1 interface comprise identities of a target that is requested to be monitored. The Delivery Function DF2 receives Intercept Related Information IRI from the network via the X2 interface. DF2 is used to distribute the IRI to relevant Law Enforcement Agencies via the HI2 interface. The Delivery Function DF3 receives Content of Communication CC, i.e. speech and data, on X3 from the ICE. Requests are also sent from the ADMF to the Mediation Function MF3 in the DF3 on an interface X1_3. The requests sent on X1_3 are used for activation of Content of Communication, and to specify detailed handling options for intercepted CC. In Circuit Switching, DF3 is responsible for call control signaling and bearer transport for an intercepted product. Intercept Related Information IRI, received by DF2 is triggered by Events that in Circuit Switching domain are either call related or non-call related. In Packet Switching domain the events are session related or session unrelated.

According to the current ETSI/3GPP LI standards there is no specific statement for instant messaging and presence interception, but a general reference to SIP enabled terminals in IP Multimedia Subsystem IMS networks that can also be used for presence and group management services. The ETSI DTS/LI-00033 just provides a very general reference to messaging and multimedia services. A problem exists because the standard DTS doesn't specify the IMPS case represented on the handover interface, i.e. it doesn't introduce the concept of IMPS communication.

### SUMMARY

The standard doesn't provide any monitoring solution at application level to facilitate monitoring also when the service is not accessed by means of an IMS core system. (Note the IMPS service could also be provided by a public network operator and still it is not possible to monitor the instant messaging and presence information when not accessed via the public IMS core system). This causes problems since monitoring of instant messaging and presence services in many cases are not possible.

The problem is solved by the invention by introducing, a new node as monitoring control element, which node relays services related to instant messaging and presence services, not only when the services are used by means of SIP clients using a public IMS core system.

More in detail, the problem is solved by a method for monitoring instant messaging and/or presence activity at application level accessible via for example Internet, 2G, 2.5G and 3G mobile networks. The method provides the following steps:
Sending from an agency to a receiving entity, a request to monitor instant messaging and/or presence activity related to a target subscriber, which information is obtainable from any type of access and not limited to SIP clients connected to a public IMS core system;
A requested activity involving the target subscriber is received from the Instant Messaging and Presence Services system to the receiving entity;
Information related to the requested activity is delivered from the receiving entity to the agency;

In one embodiment of the invention the receiving entity is an Intercept Mediation and Delivery Unit that forwards the request to the Instant Messaging and Presence Services system in which user presence and user related instant messaging is obtainable.

In another embodiment of the invention the receiving entity is a data retention system interfacing an Instant Messaging and Presence Services system in which user related instant messaging is obtainable. The receiving entity is receiving/retaining user related instant messaging from the Instant Messaging and Presence Services system.

An object of the invention is to monitor instant messaging and/or presence services that are not possible to intercept when current monitoring techniques are used. This object and others are achieved by methods, arrangements, nodes, systems and articles for manufactures.

Advantages of the invention are as follows:

### For Manufacturers

The revenues by reusing part of IMPS functionality in LI/Data Retention solution, as IAP/DRS
No major efforts are expected to integrate the IMPS equipment provided by different partners in the LI/Data Retention solution compared with the highly beneficial feature added value.

### For Operators

The possibility to provide LEA with accurate data related to interception/retention of instant messaging and presence services handled by IMPS servers under jurisdiction, regardless the type of client using the IMPS.

### Agencies

The invention introduces an accurate mechanism to intercept/retain traffic data related to IMPS across all networks: wireless, wireline and Internet.

The invention will now be described more in detail with the aid of preferred embodiments in connection with the enclosed drawings.

### BRIEF DESCRIPTION OF THE DRAWINGS

FIG. 1A is part of the prior art and discloses a block schematic illustration of Data Retention System connected to a Requesting Authority.

FIG. 1B is part of the prior art and discloses a block schematic illustration of an Intercept Mediation and Delivery Unit attached to an Intercepting Control Element.

FIG. 2 is a block schematic illustration disclosing an Instant Messaging and presence Services product acting as Intercepting Control Element attached to an Intercept Mediation and Delivery Unit.

FIG. 3 discloses a signal sequence diagram representing a method for intercepting a use case representing update presence.

FIG. 4 discloses a signal sequence diagram representing a method for intercepting a use case representing group messages (chat).

FIG. 5 discloses a block schematic illustration of a Data Retention Configuration.

FIG. 6 discloses a flow chart illustrating some essential method steps of the invention. YTC

FIG. 7 discloses a block schematic illustration of a system that can be used to put the invention into practice. YTC

### DETAILED DESCRIPTION

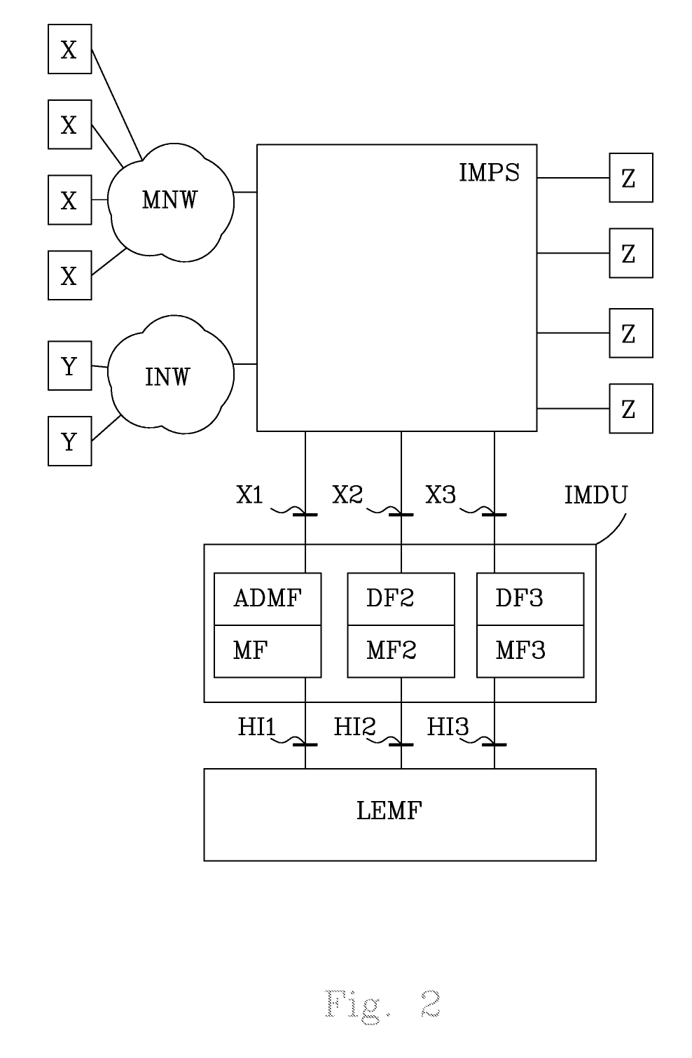

FIG. 2 discloses an Instant Messaging and Presence Services IMPS system connection overview. The system, for example the IMPS mentioned in the background section of this application, relays services related to instant messaging and presence in cases not only when the services are used by means of SIP clients using a public IMS core system. The IMPS in this example is an application designed to work across all networks; wireless, wireline and Internet. IMPS users can for example communicate over Internet, GSM and GPRS. Instant Messaging and Presence Services IMPS is a product that gives the end-user the possibility to see the presence, online status, of other IMPS users and communicate with them in the most efficient way either by IM, SMS, MMS or Voice. FIG. 2 discloses schematically the IMPS connection overview. The reference signs X in the figure represent different clients communicating with the IMPS over a mobile network MNW. Such clients X can for example be J2ME clients, WML clients, Native Mobile clients and SMS devices. The reference signs Y in the figure represent different clients communicating with the IMPS over an Internet network INW. Such clients Y can for example be PC clients or Pocket PC clients. The reference signs Z represent for example User provisioning, Offline Charging, online Charging. The invention described in this patent application is not limited to the IMPS solution shown in the figure, the solution is to be seen just as an example. To be noted is that the invention described in this patent application is not limited to the Ericsson IMPS solution.

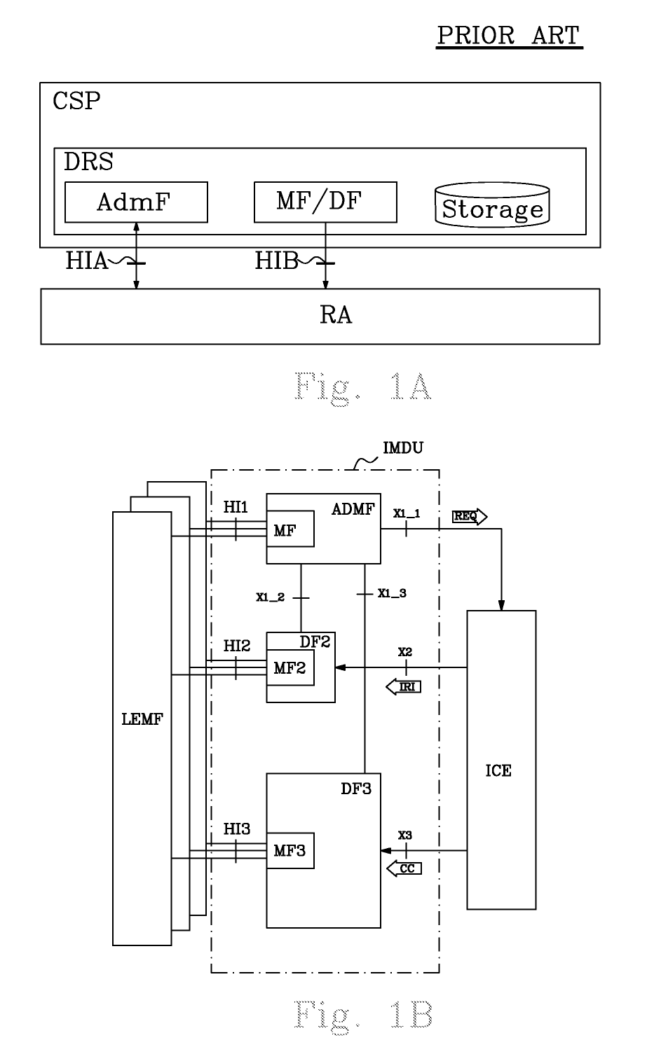

According to a first embodiment of the invention, Intercept Access Point logic has been introduced in the IMPS and the IMPS accordingly acts as an Intercepting Control Element ICE as shown in FIG. 1B. An Intercept Mediation and Deliver Unit IMDU like the one shown in FIG. 1B is schematically shown in FIG. 2. The IMDU is in this patent application also referred to as receiving entity and comprises the ADMF/MF, DF2/MF2 and DF3/MF3. The intercept unit IMDU has already been explained in the background part of this application. In this embodiment the ADMF/MF is attached to the IMPS via the interface X1 and to the LEMF via the interface HI1. The Df2/MF2 is attached to the IMPS via the interface X2 and to the LEMF via the interface HI2. The Df3/MF3 is attached to the IMPS via the interface X3 and to the LEMF via the interface HI3.

The first embodiment is directed towards Lawful Interception and comprises in a broad aspect the following steps:
The LEMF identifies a target subscriber, using instant messaging and presence services, whose traffic needs to be intercepted.
Lawful interception mediation system provisions the warrant in IMPS server.
IMPS intercepts and filters only relevant traffic and forwards raw IRIs and optionally CC (in case of instant/group messages) to the Lawful interception mediation system, when the following events happen:
   data related to instant messaging and presence services, associated to the target subscriber reaches the IMPS server.
   data are related to the originator or recipient identity under monitoring. Possible target identity types are: Calling Station Id (ex. MSISDN), User ID including domain of the user, Group Id, Contact List Id.
Lawful interception mediation system converts the intercepted traffic into the required standard format and sends it to a collection function running at the LEMF.

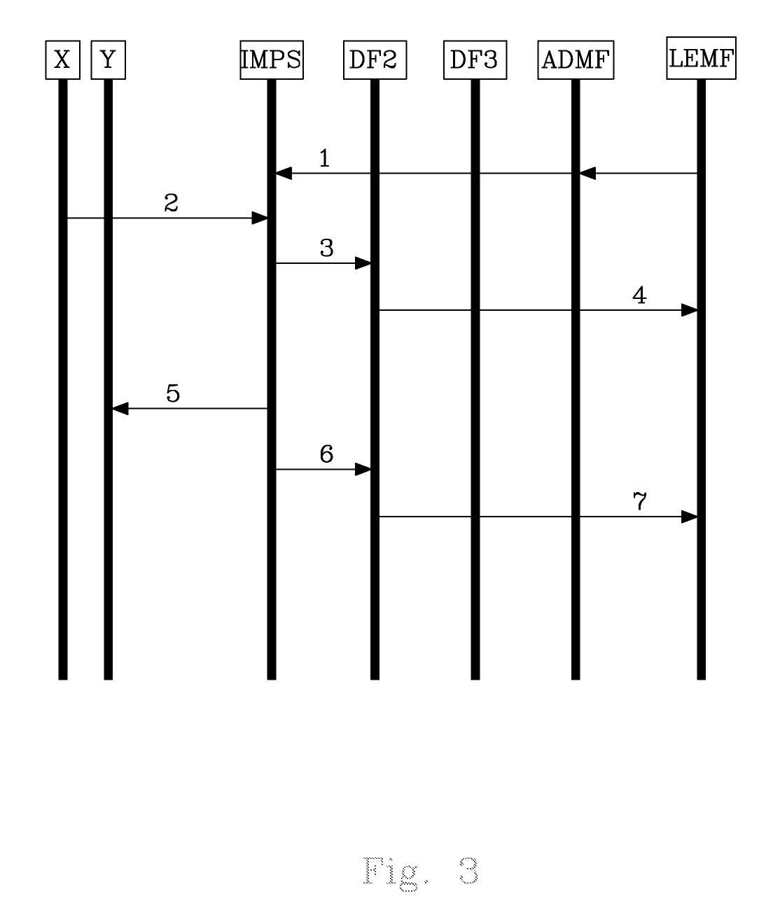

There are different use cases where the configuration in FIG. 2 can be used to exemplify the invention when directed towards Lawful Interception, for example: Login, Update presence, Instant Messaging and Group messages (Chat). An Update Presence use case will now be presented in some more details together with FIG. 3. FIG. 3 is to be read together with FIG. 2 and references like X, Y, IMPS, DF2, DF3, ADMF and LEMF has been explained in FIG. 2. FIG. 3 discloses a signal sequence diagram representing a method for intercepting presence update when user X and user Y both are targets for interception. The method according to this first example of the first embodiment comprises the following steps:
A request 1 to activate interception of user X and user Y regarding presence information is sent from the LEMF to the IMPS via the ADMF, i.e. via the receiving entity. The interfaces HI1 and X1_1 are used for delivering the request. To be noted is that under normal conditions two requests are sent i.e. one request concerning user X and one request concerning user Y. For the sake of clarity only one request is used in this example.
A presence update message 2 is sent from user X to the Instant Messaging and Presence Services IMPS. Presence is the availability and other status information of any person, application, or device to exchange information with any other person, application, or device. The power of presence is that it promises to make communication more natural and flexible; ideally, people would beforehand know the most appropriate way to get in touch with their contacts and when they are available for chat. Examples of updates are moods such as happy, sad, excited etc.
The presence update message 2 is established in the IMPS as a message related to user X for which interception is requested.
The message 2 is sent 3 on X2 from the IMPS to DF2 as Intercept Related Information IRI.
The IRI is forwarded 4 on HI2 from DF2 to the Law Enforcement Monitoring Facility LEMF.
The message 2 is sent as a presence update message 5 from the IMPS to user Y. This is because user Y has subscribed as a contact for user X.
The presence update message 5 is established in the IMPS as a message related to user Y for which interception is requested.
The message 5 is sent 6 on X2 from the IMPS to DF2 as Intercept Related Information IRI.
The IRI is forwarded 7 on HI2 from DF2 to the Law Enforcement Monitoring Facility LEMF.

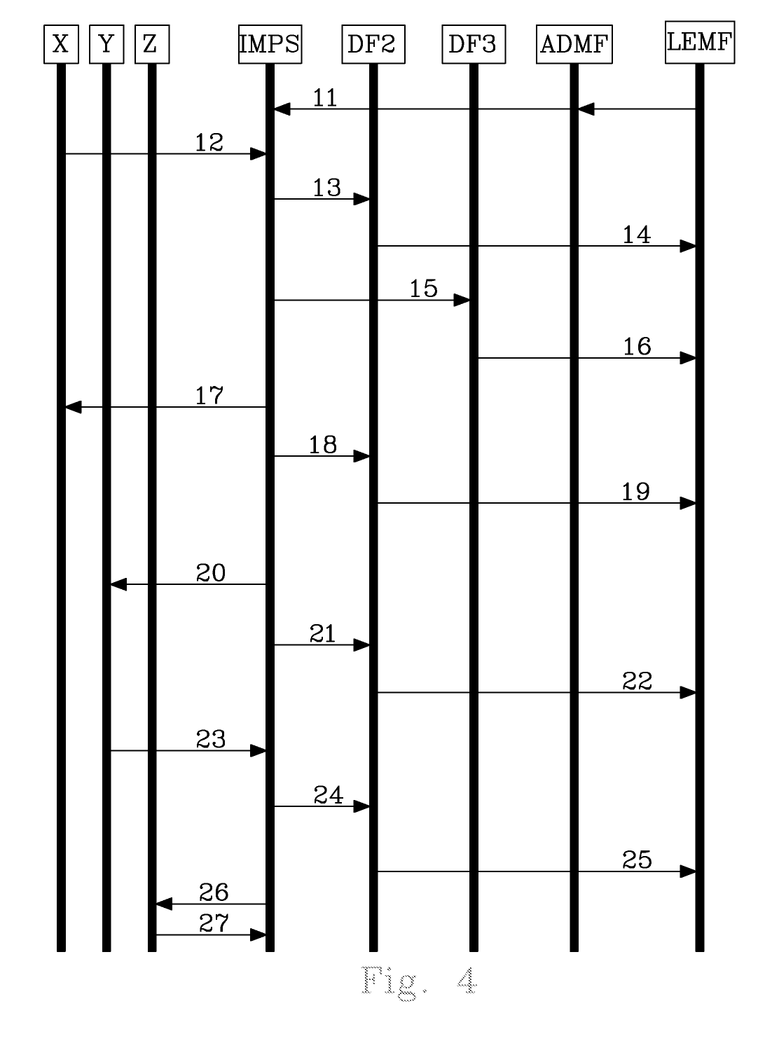

The group message (Chat) example will now be presented in some more details together with FIG. 4 as a second example of the first embodiment. Like FIG. 3, FIG. 4 is to be read together with FIG. 2 and references like X, Y, Z, IMPS, DF2, DF3, ADMF and LEMF has been explained in FIG. 2. FIG. 4 discloses a signal sequence diagram representing a method for intercepting group messages when user X and user Y, but not user Z, are targets for interception. The method according to this second example of the first embodiment comprises the following steps:
A request 11 to activate interception of user X and user Y regarding Group (Chat) information is sent from the LEMF to the IMPS via the ADMF, i.e. via the receiving entity. Content of Communication CC from user X is additionally required in the request 11. The interfaces HI1 and X1_1 are used for delivering the request. Like in the previous example, under normal conditions, two separate requests are sent.
A Group and Chat Message 12 directed towards user Y and user Z is sent from user X to the Instant Messaging and Presence Services IMPS. Group and Chat messages is the act of sending message among several users.
The Group Message 12 is established in the IMPS as a message related to user X for which interception is requested.
The message 12 is sent 13 on X2 from the IMPS to DF2 as Intercept Related Information IRI.
The IRI is forwarded 14 on HI2 from DF2 to the Law Enforcement Monitoring Facility LEMF.
Content of Communication CC, in this example chat messages content from X, is sent 15 from the IMPS to DF3 via the X3 interface.
The CC is forwarded 16 from the DF3 to the LEMF via the HI3 interface.
A Group Message Reply is sent 17 from the IMPS to the user X.
The Group Message Reply 17 is established as a message related to user X for which interception is requested and the message 17 is sent 18 on X2 from the IMPS to DF2 as Intercept Related Information IRI.
The IRI is forwarded 19 on HI2 from DF2 to the Law Enforcement Monitoring Facility LEMF.
Since user Y is appointed as one of the recipients, the Group Message 12 is forwarded 20 to the user Y and user Y sends 23 a Group Message Reply to IMPS.
Like in the previous steps, IRI related to the Group Message is sent 21, 22 to the LEMF, and IRI related to the Group Message Reply message is sent 24, 25 to LEMF. CC from user Y will not be forwarded since it was not requested.
Since user Z also is appointed as one of the recipients, the Group Message 12 is forwarded 26 to the user Z and user Z sends 27 a Group Message Reply to IMPS. Due to the fact that user Z not has been appointed as target for interception, no IRI or CC will be forwarded to the LEMF.

Other examples of use cases out of the two use cases shown above are Instant Messaging and Login. The login use case is about the behaviour when a user logs in to the IMPS. Instant messaging will be discussed below in this application in connection with a second embodiment. Also other IMPS use cases can be considered.

The invention impacts on the 3GPP, ETSI and ANSI standards for the HI2 and HI3 interface and for the interception domain. The following target identity type shall be introduced for the IMPS interception:
Calling Station Id, that is customer Number, ex. MSISDN
User Name, that is the User ID including domain of the user
Group Id
Contact List Id

The following HI2 main parameters shall be:

| | |
|---|---|
| Reference Point | Originating or Terminating event |
| Client Type | Mobile Phone, Computer, PDA, CLI, |
| | SSP, WML, Other or Unknown |
| Calling Station Id | Customer Number, ex. msisdn |
| Recipient(s) | User ID, Group Id or Contact List Id |
| Address | |
| Protocol | HTTP, WSP, SMPP |
| Event Type | Login, Logout, Create group, |
| | Create contactlist, Create |
| | attributelist, Delete group, |
| | Delete contactlist, Delete |
| | attributelist, Send, Invite |
| | to group, Invite to |
| | messaging, Invite to |
| | presence, Subscribe presence |
| | contactlist, |
| | Subscribe presence user, |
| | Subscribe group change |
| | notice, |
| | Unsubscribe presence |
| | contactlist, Unsubscribe |
| | presence user, Unsubscribe |
| | group change notice, Join |
| | group, Leave group, Update |
| | presence, Add contact (to |
| | contactlist), Remove contact |
| | (from contactlist) |
| Time Of Event | Date and Time of the event |
| Feature | Access, Common, IM, Group or |
| | Presence |
| User Name | The User ID including domain of the |
| | user |
| Message Content | e.g. text/plain |
| Message Size | Size of message (in octets) |

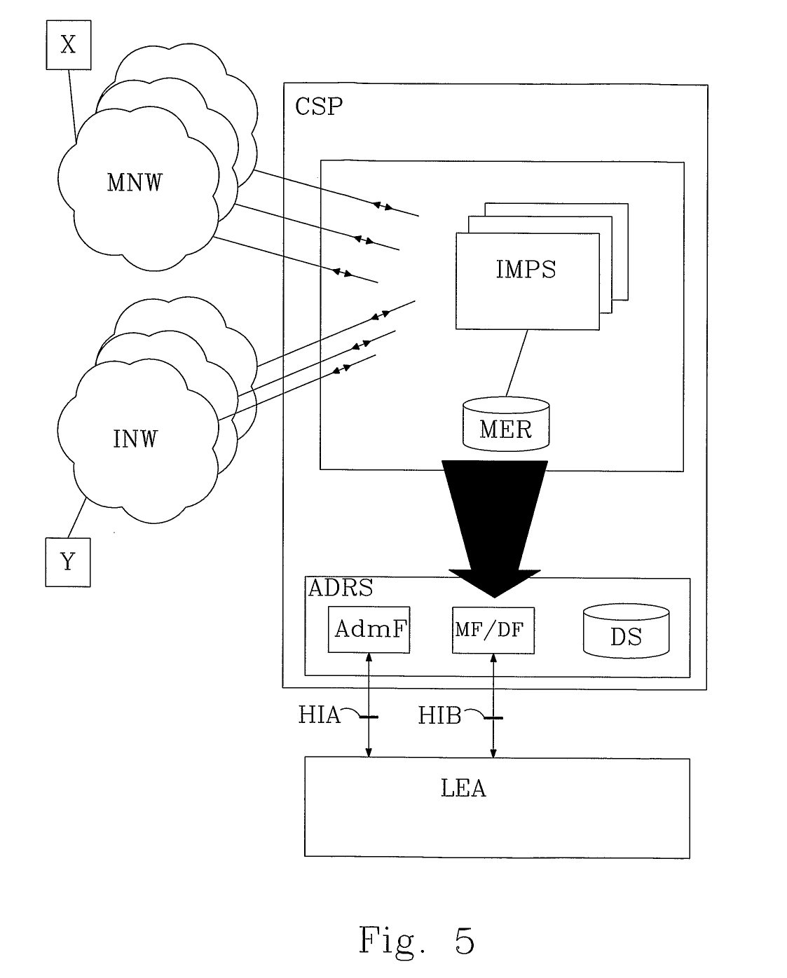

FIG. 5 discloses in a second embodiment a Data Retention configuration. FIG. 5 shows Instant Messaging and Presence Services IMPS systems of the type earlier shown in FIG. 2. As can be seen schematically in the figure, the IMPSs send/receive instant messaging information to/from networks like for example mobile networks MNW and internet networks INW. Message records generated in the IMPS systems are received by a Message Event Repository MER. The IMPS is acting as data retention source but in this second embodiment, presence service related data shall not be retained because they are not communication related. Data to be retained, i.e. in this example Message Data Records related to Instant Messaging are transported from MER to a Mediation and Delivery function MF/DF. The transportation of data from the MER to the MF/DF is schematically shown with a filled arrow in FIG. 5. Data records are transferred (e.g. using SFTP) to the mediation function in the automatic data retention system, and then data fulfilling configured filtering criteria are mediated from MF/DF to storage DS, and stored in the DS. Updating of the Data Storage DS depends on the policy regulating the notifications with the user, session or operator related data, from the IMPS towards the storage. Accordingly, the transportation of the data from MER to DS via the MF/DF is handled by an automatic data retention system. The automatic data retention system is part of the prior art and the transportation of data is a pre-requisite for this invention. An Automatic Data Retention Solution ADRS of similar type as the DRS mentioned earlier together with FIG. 1A can be seen in FIG. 5. The ADRS is in this patent application also referred to as receiving entity. The ADRS is attached to a Law Enforcement Agency LEA. The ADRS and the LEA are connected via the already explained interfaces HIA and HIB. The ADRS comprises an Administration Function AdmF used to handle and forward requests from/to the LEA. A Mediation and Delivery function MF/DF is used to mediate and deliver requested information. The Storage DS in ADRS is used to collect and retain data from MER.

The second embodiment of the invention will now be explained. In this embodiment Instant Messaging data from the accessible “not IMS” nodes IMPSs have been transported to MER and according to present policy then further mediated and stored in the Data Store DS. Instant messaging is the act of sending messages to recipients and delivering them more or less instantly, without the need for the recipient to specifically fetch the messages. The combining of presence, instant messaging and mobility that can be used anytime and anywhere, enables powerful communications possibilities. It opens up new business opportunities as well as creates multiple new services in the mobile communication domain. Not only can mobile users communicate with other mobile users but also with using PCs, PDAs and other devices. The method in this second embodiment comprises the following steps:
An Instant Message is sent from user X to the IMPS. User Y is pointed out as receiver of the message and the Instant Message is forwarded from the IMPS to user Y.
The Message Event Repository MER constantly gather information from the different Instant Messaging and Presence Services IMPS systems, and Instant Message data records concerning the message received from user X with user Y as receiver are sent from the IMPS to the MER.
Data records are transferred (e.g. using SFTP) to the mediation function in the automatic data retention system, and then according to current policies the mediated records are forwarded and stored in the DS.

The method in this second embodiment comprises according to the invention the following further steps:
A monitoring request regarding Instant Messaging is determined by the Law Enforcement Monitoring Facility LEA and sent to the AdmF. Generally, the criteria stem from a search request or other authorization from a government or other authorized institution. User Y is target for the monitoring. In this example the criteria are sent from the LEA but may also be communicated by an intermediary, such as a human operator who receives the command from an authorized source, and then inputs the criteria to the ADRS.
The monitoring request is received by the Administration Function AdmF via the interface HIA.
The AdmF informs the Mediation and Delivery function MF/DF of the request.
The Instant Message data records related to user Y are found and fetched by the Mediation and Delivery function MF/DF from the DS.
The Instant Message data records are sent as Message Data Records from the MF/DF on the interface HIB, to the LEA. In case there are no records meeting the request criteria, a response is still sent, containing zero records.

The reciprocal signaling between the above different Data Retention entities is to be seen just as example. For example can the DS be an integrated part of the MF/DF. The MER can for example under certain circumstances be excluded. This is all obvious to someone skilled in the art.

The DR related standards are in a very preliminary state. There is no detailed handover interface specified and there is no plan to investigate in the ETSI standard body on the DRS's to integrate. Most likely, a DR solution will integrate as DRS's all types of network elements (MSC, GGSN, . . . ) that are integrated as IAP in the LI solution. Instead, IMPS system shall be considered a new network element type, since it is new for both solutions. Some of the main data to retain for IMPS are:

| | |
|---|---|
| Reference Point | Originating or Terminating event |
| Client Type | Mobile Phone, Computer, PDA, CLI, |
| | SSP, WML, Other or Unknown |
| Calling Station Id | Customer Number, ex. msisdn |
| Recipient(s) Address | User ID, Group Id or Contact List Id |
| | (when providing the Group ID or the |
| | Contact list Id, the corresponding list of |
| | addresses shall be provided as well). |
| Protocol | HTTP, WSP, SMPP |
| Event Type | Instant message, Group |
| | message. |
| Time Of Event | Date and Time of the event |
| User Name | The User ID including domain of the |
| | user |
| Message Content | e.g. text/plain |
| Message Size | Size of message (in octets) |

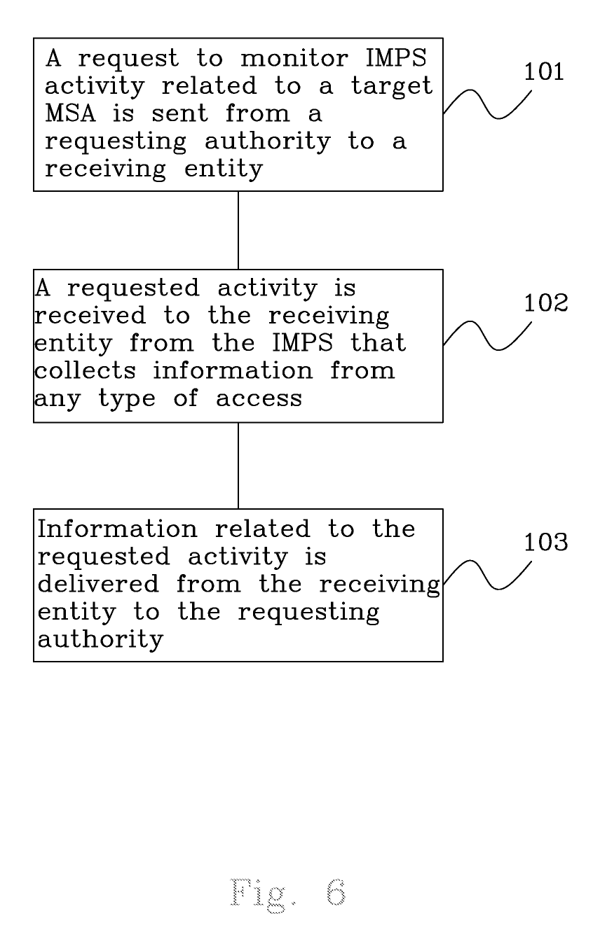

FIG. 6 discloses a flow chart illustrating some essential method steps of the invention. The flow chart is to be read together with the earlier shown figures. The flow chart comprises the following steps:
A request to monitor IMPS activity related to a target MSA is sent from a requesting authority to a receiving entity. The receiving entity is either an Intercept Mediation and Deliver Unit or a data retention system. This step is shown in the figure with a block 101.
A requested activity is received to the receiving entity from the IMPS. The IMPS gather information obtainable from any type of access. This step is shown in the figure with a block 102.
Information related to the requested activity is delivered from the receiving entity to the requesting authority.

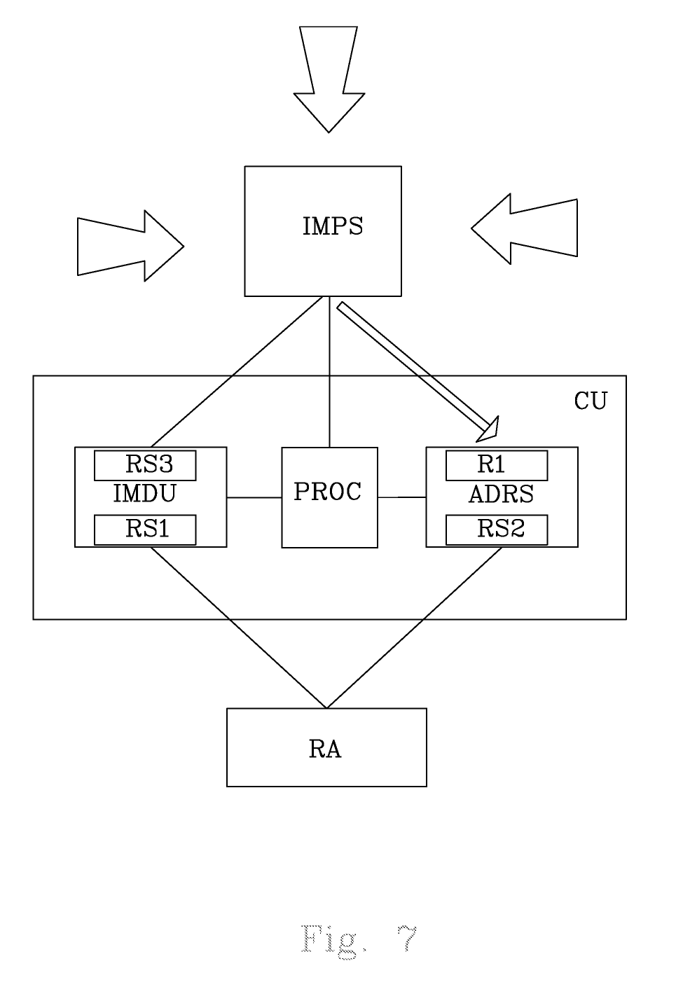

A system that can be used to put the invention into practice is schematically shown in FIG. 7. The block schematic constellation corresponds in many parts to the one disclosed in the FIGS. 2 and 5. The system comprises a central unit CU comprising a processor PROC, an Intercept Mediation and Delivery Unit IMDU and an Automatic Data Retention Solution ADRS. The IMDU, also called a first node, comprises a send/receive element RS1. Control commands, e.g. from an agency are received to the IMDU via RS1. The commands are forwarded to an IMPS via a send/receive element RS3. The IMPS receives Instant Messaging and/or Presence information from external clients over networks. The input of information is shown in the figure with unfilled arrows. The IMPS can forward information to the ADRS in the CU. The ADRS, also called a second node, comprises a send/receive element RS2. Control commands, e.g. from an agency are received to the IMDU via RS2. Information forwarded from the IMPS is received to the ADRS via a receive element R1 and retained in the ADRS. The processor is capable to handle the control of the different entities in the central unit. The IMDU and the ADRS forward requested information to a Requesting Authority RA via the interfaces RS1 and RS2.

Enumerated items are shown in the figure as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The invention is of course not limited to the above described and in the drawings shown embodiments but can be modified within the scope of the enclosed claims. To be noted is that the invention described in this patent application is not limited to the Ericsson IMPS solution. The Ericsson IMPS solution is to be seen just as an example.

1. A method for monitoring instant messaging and/or presence activity at application level in a telecommunication system, which method comprises is by the following steps:
sending from an agency to a receiving entity, a request to monitor instant messaging and/or presence activity information related to a target subscriber, which information is obtainable from any type of access and not limited to SIP clients connected to a public IMS core system;
receiving a requested activity involving the target subscriber from an Instant Messaging and Presence Services (IMPS) system to the receiving entity; and
delivering information related to the requested activity, from the receiving entity to the agency.

2. The method for monitoring instant messaging and/or presence activity according to claim 1, wherein the receiving entity is an Intercept Mediation and Deliver Unit (IMDU).

3. The method for monitoring instant messaging and/or presence activity according to claim 2, which method comprises the following further steps:
the request to monitor instant messaging and/or presence activity is forwarded from the receiving entity to the Instant Messaging and Presence Services (IMPS) system;

4. The method for monitoring instant messaging and/or presence activity according to claim 1, wherein the receiving entity is a data retention system (ADRS), whereby the receiving entity automatically receives/retains user related instant messaging from the Instant Messaging and Presence Services (IMPS).

5. The method for monitoring instant messaging and/or presence activity according to claim 1 wherein the Instant Messaging and Presence Services (IMPS) system represents a domain and an interface is used to connect the domain with at least one other Instant Messaging and Presence Services domain, which interface is used for interworking between the domains.

6. The method for monitoring instant messaging and/or presence activity according to claim 5 wherein one of the at least one other domains provides presence and group management services for SIP enabled terminals in IMS networks.

7. The method for monitoring instant messaging and/or presence activity according to claim 1 which information is delivered from the receiving entity to the agency as Interception Related Information.

8. The method for monitoring instant messaging and/or presence activity according to claim 1 which information is delivered from the receiving entity to the agency as Content of Communication.

9. An apparatus for monitoring instant messaging and/or presence activity at application level in a telecommunication system, the apparatus comprising:
means for sending from an agency to a receiving entity, a request to monitor instant messaging and/or presence activity information related to a target subscriber, which information is obtainable from any type of access and not limited to SIP clients connected to a public IMS core system;
means for receiving a requested activity involving the target subscriber from an Instant Messaging and Presence Services (IMPS) system to the receiving entity; and
means for delivering information related to the requested activity, from the receiving entity to the agency.

10. The apparatus for monitoring instant messaging and/or presence activity according to claim 9, wherein the receiving entity is an Intercept Mediation and Deliver Unit (IMDU).

11. The apparatus for monitoring instant messaging and/or presence activity according to claim 10, further comprising:
means to forward the request to monitor instant messaging and/or presence activity from the receiving entity to the Instant Messaging and Presence Services (IMPS) system.

12. The apparatus for monitoring instant messaging and/or presence activity according to claim 9, wherein the receiving entity is a data retention system (ADRS), whereby the receiving entity automatically receives/retains user related instant messaging from the Instant Messaging and Presence Services (IMPS).

13. The apparatus for monitoring instant messaging and/or presence activity according to claim 9 wherein the Instant Messaging and Presence Services (IMPS) system represents a domain and an interface is used to connect the domain with at least one other Instant Messaging and Presence Services domain, which interface comprises means for interworking between the domains.

14. The method for monitoring instant messaging and/or presence activity according to claim 13 wherein one of the at least one other domains provides presence and group management services for SIP enabled terminals in IMS networks.

15. A Node for monitoring instant messaging and/or presence activity at application level in a telecommunication system, the node comprising:
means for receiving to the node a request to monitor instant messaging and/or presence activity information related to a target subscriber, which information is obtainable from any type of access and not limited to SIP clients connected to a public IMS core system;
means for forwarding the request to monitor instant messaging and/or presence activity from the node to an Instant Messaging and Presence Services (IMPS) system in which information is obtainable from any type of access and not limited to SIP clients connected to a public IMS core system;
means for receiving a requested activity involving the target subscriber from the Instant Messaging and Presence Services (IMPS) system to the node; and
means in the node for delivering information related to the requested activity.

16. A Node for monitoring instant messaging and/or presence activity at application level in a telecommunication system, comprised by:
means for receiving to the node a request to monitor instant messaging and/or presence activity information related to a target subscriber, which information is obtainable from any type of access and not limited to SIP clients connected to a public IMS core system;
means in the node for receiving/retaining user related Instant Messaging from an Instant Messaging and Presence Services (IMPS) in which information is obtainable from any type of access and not limited to SIP clients connected to a public IMS core system; and
means in the node for delivering information related to the requested activity.

17. Article for manufacture comprising a program storage having computer readable program code embodied therein for monitoring instant messaging and/or presence activity at application level in a telecommunication system, the article for manufacture comprising:
computer readable program code to send from an agency to a receiving entity, a request to monitor instant messaging and/or presence activity information related to a target subscriber, which information is obtainable from any type of access and not limited to SIP clients connected to a public IMS core system;
computer readable program code to receive a requested activity involving the target subscriber from an Instant Messaging and Presence Services system to the receiving entity; and
computer readable program code to deliver information related to the requested activity, from the receiving entity to the agency.
